(19) United States
(12) Patent Application Publication
(10) Pub. No.: US 2012/0147813 A1
(43) Pub. Date: Jun. 14, 2012

(54) CLOSED-LOOP FEEDBACK DURING INITIAL RANGING PROCEDURE

(75) Inventors: Eugene Visotsky, Buffalo Grove, IL (US); Mark C. Cudak, Rolling Meadows, IL (US); William J. Hillery, Lafayette, IN (US); Arvind Krishnamoorthy, Bartlett, IL (US); Bishwarup Mondal, Oak Park, IL (US); Frederick W. Vook, Schaumburg, IL (US)

(73) Assignee: MOTOROLA, INC., Libertyville, IL (US)

(21) Appl. No.: 12/965,949

(22) Filed: Dec. 13, 2010

(51) Int. Cl. H04W 4/00

(52) U.S. Cl. 370/328

(57) ABSTRACT

During operation, the choice of the initial ranging code (sometimes referred to as a ranging preamble code, or a random-access preamble) at the mobile station is associated with a PMI feedback to be signaled to the base station during the initial ranging. More particularly, during initial system access a ranging code is transmitted by the mobile station to the base station. The mobile station chooses one of the available ranging codes based on the channel conditions and associates the ranging code with channel feedback information. The ranging code is then transmitted to the base station, and provides the base station with the channel feedback information.

### FIELD OF THE DISCLOSURE

The present disclosure relates generally to wireless communications and more particularly to closed-loop channel feedback in wireless communication systems during initial system access.

### BACKGROUND

In wireless communication systems, transmission techniques involving multiple antennas are often categorized as open-loop or closed-loop, depending on the level or degree of channel response information used by the transmission algorithm. Open-loop techniques do not rely on the information of the spatial channel response between the transmitting device and the receiving device. They typically involve either no feedback or the feedback of the long term statistical information that a base unit may use to choose between different open loop techniques. Open-loop techniques include transmit diversity, delay diversity, and space-time coding techniques such as the Alamouti space-time block code.

Closed-loop transmission techniques utilize knowledge of the channel response to weight the information transmitted from multiple antennas. To enable a closed-loop transmit array to operate adaptively, the array must apply the transmit weights derived from the channel response, its statistics or characteristics, or a combination thereof. There are several methodologies for enabling closed-loop transmission. All of these methodologies require some sort of channel information being fed back to the transmitter. Exemplary closed-loop methodologies include adaptive transmit beam-forming (sometimes referred to as transmit adaptive array (TXAA) transmission), closed-loop single-user MIMO, closed-loop multi-user MIMO, and coordinated multi-point transmission (or CoMP). In these methodologies, the transmitter applies weighting coefficients that are derived according to an optimization algorithm to control characteristics of the transmitted signal energy.

One methodology for enabling closed-loop transmission is codebook index feedback in which both the BS and MS maintain a finite codebook of possible transmit weight vectors or matrices, depending on the number of simultaneous transmit beams being formed. The MS measures the downlink multi-antenna channel response and computes the transmit weight vector or matrix that is best used to transmit information. The MS then transmits the index into the codebook back to the BS, where the index into the codebook is often called a Precoding Matrix Index (PMI). The BS uses the transmit weight vector or matrix corresponding to the index fed back by the MS. Codebook index feedback can be applied to both FDD and TDD systems.

Another methodology for enabling closed-loop transmission is quantized channel feedback wherein the MS measures the downlink channel and quantizes the channel response into digital form in which some number of bits are used to convey gain information and some number of bits are used to convey phase information for a given channel coefficient. Variations on this methodology are also possible, such as quantizing the spatial covariance matrix and sending back a feedback message consisting of some pre-determined number of bits that represent the covariance matrix.

A current problem exists with initial mobile station network entry. Since during a mobile station's initial system access, the base station has no indication of the downlink channel, the base station is unable to apply appropriate transmit antenna weighting coefficients when responding to an initial ranging or random access request from the mobile station. Because it is imperative to enable closed loop TXAA techniques during network entry and initial ranging, a need exists to provide the base station channel information during the mobile station network entry. Therefore a need exists for a method and apparatus for closed-loop channel feedback in wireless communication systems during initial system access.

### BRIEF DESCRIPTION OF THE DRAWINGS

FIG. 1 is a wireless communication system.

FIG. 2 is a block diagram of a closed-loop transmit antenna array communicating a single data stream to a receiving device.

FIG. 3 is a block diagram of a closed-loop transmit antenna array communicating multiple data streams to a receiving device.

FIG. 4 is a block diagram of a mobile station using the codebook-based PMI feedback method.

FIG. 5 is a block diagram for a base unit using a PMI feedback from a mobile station.

FIG. 6 is a flow chart showing operation of the mobile station of FIG. 4.

FIG. 7 is a flow chart showing operation of the base station of FIG. 5.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

In order to address the above-mentioned need, a method and apparatus for providing channel feedback is provided herein. During operation, the choice of the initial ranging code (sometimes referred to as a ranging preamble code, or a random-access preamble) at the mobile station is associated with a PMI feedback to be signaled to the base station during the initial ranging. More particularly, during initial system access a ranging code is transmitted by the mobile station to the base station. The mobile station measures the downlink channel, determines the channel feedback information (e.g., PMI) based on the channel conditions, and associates the ranging code with channel feedback information. The ranging code is then transmitted to the base station and provides the base station with the channel feedback information.

As a result, the base station is provided with channel information prior to the mobile station accessing the system, and the base station can tailor any transmissions to the mobile station accordingly. This allows for the system to apply per-user closed loop techniques on the DL control channel when transmitting DL unicast control messages to the mobile station. This will significantly improve range and reliability of the control channel used in IEEE 802.16m or the Long Term Evolution (LTE) of the 3GPP UMTS standard.

The present invention encompasses a method for a mobile unit to provide closed-loop feedback to a base station. The method comprises the steps of determining appropriate downlink channel information to feed back to the base station as part of a closed-loop feedback of the downlink channel information, associating the downlink channel information with a numerical sequence used for initial access to a communication system, and sending a request to join the communication system, the request comprising the numerical sequence. In response, downlink control channel transmissions are received from the base station that are weighted based on the numerical sequence.

The present invention encompasses a method for a mobile unit to provide closed-loop feedback to a base station. The method comprises the steps of determining a precoding matrix index (PMI) to feed back to the base station as part of a closed-loop feedback of the downlink channel information, associating the PMI with a ranging code or a random-access preamble used for initial access to a communication system, and sending a request to join the communication system, the request comprising the ranging code or random-access preamble. In response, downlink control channel transmissions are received from the base station that are weighted based on the PMI.

The present invention additionally encompasses a method for a base station to provide appropriate channel weightings to a mobile unit during closed-loop feedback. The method comprises the steps of receiving a request to join a communication system, the request comprising a numerical sequence, determining downlink antenna weights to utilize when transmitting to the mobile station based on the numerical sequence, and transmitting information on a downlink control channel, appropriately weighted with the chosen antenna weights

The present invention encompasses an apparatus comprising: calculation circuitry determining appropriate downlink channel information to feed back to the base station as part of a closed-loop feedback of the downlink channel information, logic circuitry associating the downlink channel information with a numerical sequence used for initial access to a communication system, a transmitter sending a request to join the communication system, the request comprising the numerical sequence, and a receiver receiving downlink control channel transmissions from the base station that are weighted based on the numerical sequence.

The present invention encompasses an apparatus comprising a receiver receiving a request to join a communication system, the request comprising a numerical sequence, logic circuitry determining a precoding matrix index (PMI) based on the numerical sequence and also determining downlink antenna weights to utilize when transmitting to the mobile station, and a transmitter transmitting information on a downlink control channel, the information appropriately weighted with the chosen antenna weights.

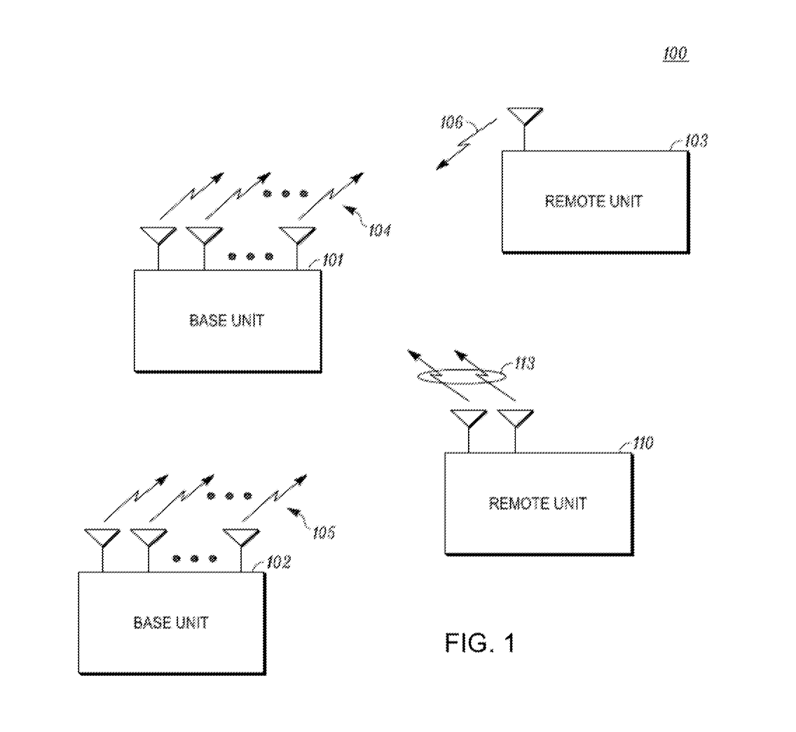

In FIG. 1, the wireless communication system 100 includes one or more fixed base infrastructure units forming a network distributed over a geographical region. The base unit may also be referred to as an access point, access terminal, base station, Node-B, eNode-B, or by other terminology used in the art. In FIG. 1, the one or more base units 101 and 102 serve a number of remote units 103 and 110 within a serving area, for example, a cell, or within a cell sector. In some systems, one or more base units are communicably coupled to a controller forming an access network that is communicably coupled to one or more core networks. The disclosure is not intended to be limited to any particular wireless communication system, however two systems that can benefit from the technique described herein are systems utilizing the IEEE 802.16m standard, or the LTE of the 3GPP UMTS standard.

For illustration purposes, communication system 100 will be described using a codebook index feedback technique in which both the base station and mobile station maintain one or more finite codebooks of possible transmit weight vectors or matrices, depending on the number of simultaneous transmit beams being formed. The mobile station measures the downlink multi-antenna channel response and computes the transmit weight vector or matrix that is best suited to transmit information to itself from the base station. Specifically a mobile station chooses the best transmit weight vector or matrix to optimize the data reception performance when the same transmit weight vector or matrix is used by the base station to transmit data to the mobile station. A mobile station may also choose multiple elements (vectors or matrices) from one or more codebooks and combine them to construct a single transmit weight vector or matrix.

While choosing multiple elements the goal is to optimize the data reception performance when the transmit weight vector or matrix as constructed from the combination is used by the base station to transmit data to the mobile station. The mobile station then transmits the index into the codebook back to the base station, where the index into the codebook is often called a Precoding Matrix Index (PMI). The base station uses the transmit weight vector or matrix corresponding to the index fed back by the mobile station. The particular codebook that a mobile station and a base station uses may change from time to time. The base station has the flexibility to change the transmit weight vector or matrix recommended by the mobile station for transmission. Codebook index feedback can be applied to both frequency division duplex (FDD) and time division duplex (TDD) systems.

Generally, the serving base units 101 and 102 transmit downlink communication signals 104 and 105 to remote units in the time and/or frequency domain. Remote units 103 and 110 communicate with one or more base units 101 and 102 via uplink communication signals 106 and 113. The one or more base units may comprise one or more transmitters and one or more receivers that serve the remote units. The remote units may be fixed or mobile user terminals. The remote units may also be referred to as subscriber units, mobile stations (MSs), users, terminals, subscriber stations, user equipment (UE), user terminals, or by other terminology used in the art. The remote units may also comprise one or more transmitters and one or more receivers. The remote units may have half duplex (HD) or full duplex (FD) transceivers. Half-duplex transceivers do not transmit and receive simultaneously whereas full duplex terminals do.

In the preferred embodiment, the communication system utilizes orthogonal frequency division multiple access (OFDMA) or a multi-carrier based architecture on the downlink and for uplink transmissions. Exemplary OFDMA based protocols include the Long Term Evolution (LTE) of the 3GPP UMTS standard and IEEE 802.16 standard. Although the preferred embodiment utilized OFDMA, other modulation methods may also be employed such as interleaved frequency-division multiple access (IFDMA), DFT spread OFDM, multi-carrier code-division multiple access (MC-CDMA), multi-carrier direct sequence CDMA (MC-DS-CDMA), Orthogonal Frequency and Code Division Multiplexing (OFCDM), or cyclic-prefix single carrier.

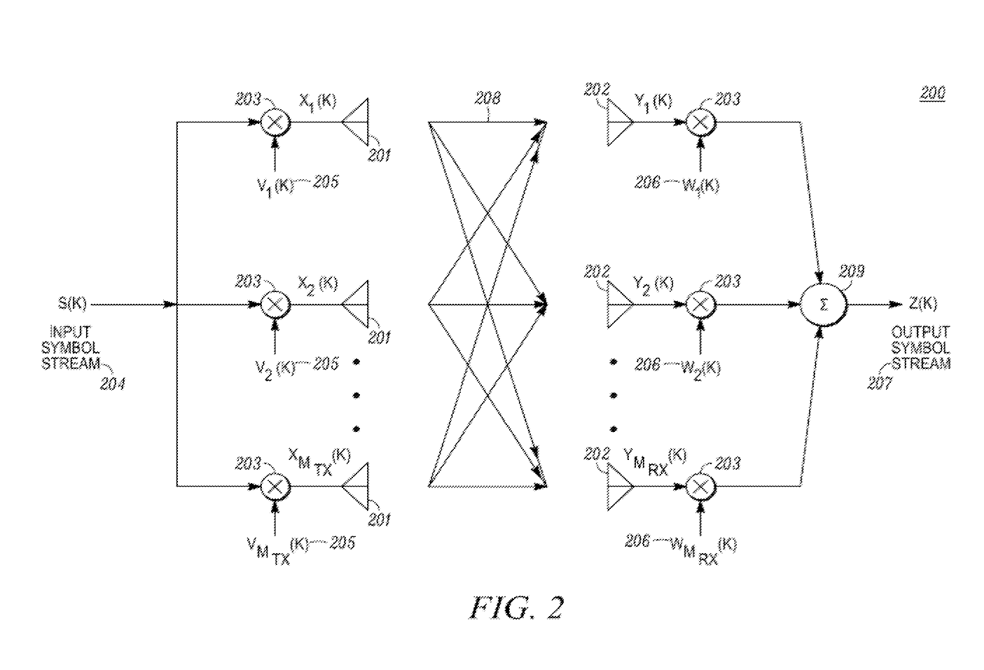

FIG. 2 is a block diagram of a closed-loop transmit antenna array as part of a base unit communicating a single data stream to a receiving device as part of a remote unit having one or more receive antennas. Input stream 204 is multiplied by transmit weights 205 using multipliers 203 before being fed to the multiple transmit antennas 201. Multiplying input stream 204 by transmit weights 205, where the transmit weights are based on at least a partial channel response, is an example of tailoring a spatial characteristic of the transmission. The transmit weights are calculated from fed-back PMI information. The signals transmitted from the multiple transmit antennas 201 propagate through a matrix channel 208 and are received by multiple receive antennas 202. The signals received on the multiple receive antennas 202 are multiplied by receive weights 206 using multipliers 203 and summed by a summation device 209 to produce an output symbol stream 207. In embodiments where the transmitter has only a single antenna, the spatial characteristic of the transmit signal cannot be tailored. However, other characteristics of the transmit signal may be tailored based on at least a partial channel response, such as the complex gain of each sub-carrier (e.g., in a pre-equalization application), or the modulation and coding used on the sub-carriers of the transmit signal.

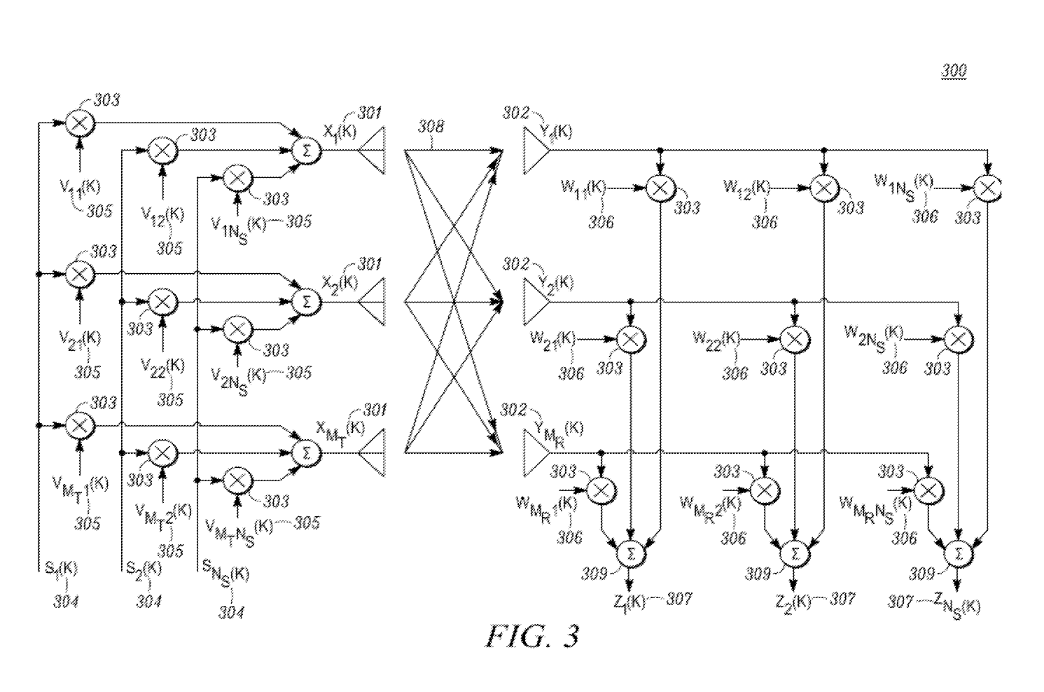

FIG. 3 is a block diagram of a closed-loop transmit antenna array as part of a base unit communicating multiple data streams to a remote unit having one or more receive antennas, for example, a MIMO system. Multiple input streams 304 are multiplied by transmit weights 305 using multipliers 303 before being fed to the multiple transmit antennas 301. The signals transmitted from the multiple transmit antennas 301 propagate through a matrix channel 308 and are received by multiple receive antennas 302. The signals received on the multiple receive antennas 302 are multiplied by receive weights 306 using multipliers 303 and summed by summation devices 309 to produce the multiple output symbol streams 307. Multiplying input streams 304 by transmit weights 305 where the transmit weights are based on at least a partial channel response is another example of tailoring a spatial characteristic of the transmission. Other schemes for producing the output symbol streams 307 are possible, such as maximum likelihood detection or successive cancellation that may or may not use the receive weights 306 and the multipliers 303.

As discussed above, a current problem exists with initial mobile station network entry. Since during a mobile station's initial system access, the base station has no indication of the downlink channel state (since no PMI has been fed back to the base station), the base station is unable to choose appropriate transmit weights. In order to address this issue, the choice of the initial ranging code or random-access preamble at the mobile station is associated with the DL PMI feedback to be signaled to the base station during the initial ranging (or LTE random access procedure). More particularly, during initial system access a ranging code or random-access preamble is transmitted by the mobile station to the base station. When the base station receives a ranging code, it is required to estimate the timing offset and the power for the mobile station. The base station then broadcasts the detected ranging code with adjustment instructions for the timing and power level. The status notifications of either ranging successful or retransmission are also broadcasted. In prior-art initial ranging, the mobile station chooses one of the available ranging codes randomly and transmits it twice over two consecutive OFDM symbols with BPSK modulation. However, in the present invention, the mobile station chooses one of the available ranging codes based on the channel conditions and associates the ranging code with a PMI index. The ranging code is then transmitted twice over two consecutive OFDM symbols with BPSK modulation.

Currently, PMI or other forms of channel state information are quantized to obtain feedback of certain bit length. Specifically in the IEEE 802.16m working group, it is agreed that 4 bits of feedback will be used to specify one of the 16 possible PMIs. In the present invention each of the 16 possible PMIs are associated with a particular ranging code (or multiple codes). For instance, the 64 initial ranging codes are divided into 16 groups of four codes each. To signal a specific 4-bit PMI value, a mobile station transmits one of the four codes from the ranging code group corresponding to its observed PMI. The choice of the specific ranging code from the ranging code group is pseudorandom to minimize collision probability. Furthermore, the overall increase in collision probability in the initial ranging channel is expected to be negligible with this scheme, as PMI values should be uniformly distributed across mobile stations performing initial ranging from varying locations throughout the cell and observing various fading channel conditions. Clearly, a minimum of 16 initial ranging codes are necessary to convey 4-bit PMI values to the base station.

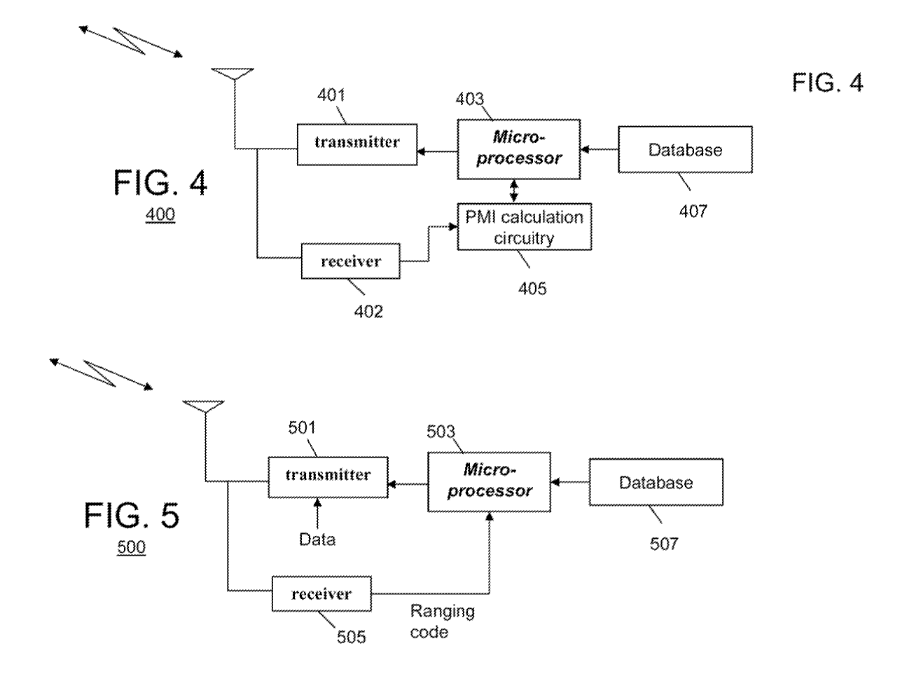

FIG. 4 is a block diagram of mobile station 400 using the codebook-based PMI feedback method. As shown, mobile station 400 comprises logic circuitry 403, receive circuitry 402, transmit circuitry 401, PMI calculation circuitry 405, and database 407. Logic circuitry 403 preferably comprises a microprocessor controller, such as, but not limited to an ARM11 microprocessor. Logic circuitry 403 serves as means for controlling mobile station 400. Additionally receive and transmit circuitry are common circuitry known in the art for communication utilizing well known communication protocols (e.g., 802.16 or LTE), and serve as means for transmitting and receiving voice and data. Database 407 comprises standard random access memory and is used to store PMI values and their associated ranging code.

During initial system access, receiver 402 receives channel information, which preferably comprises pilot symbols transmitted from a base station. PMI calculation circuitry 405 calculates an appropriate PMI to feed back to the base station. The appropriate PMI is passed to logic circuitry 403 where logic circuitry 403 associates the PMI with an appropriate ranging code or LTE random-access preamble.

As discussed above the ranging code or random-access preamble preferably comprises one of a finite number of numerical sequences that is utilized to signal a request for network entry from a mobile station to a base station. These sequences are defined in the IEEE 802.16 specification in section 16.3.8.2.4 or in the LTE specification 36.211 at section 5.7, both sections of which are incorporated by reference herein. The choice of the specific ranging code from the possible ranging codes is pseudorandom to minimize collision probability. Logic circuitry then instructs transmitter 401 to transmit the chosen ranging code as part of an initial system access. As discussed, the ranging code will convey an appropriate PMI to the base station, causing the base station to choose appropriate channel weights based on the ranging code used.

FIG. 5 is a block diagram for a base unit using a PMI feedback from a mobile station. As shown, base station 500 comprises logic circuitry 503, receive circuitry 505, transmit circuitry 501, and database 507. Logic circuitry 503 preferably comprises a microprocessor controller, such as, but not limited to an ARM11 microprocessor. Logic circuitry 503 serves as means for controlling base station 500. Additionally receive and transmit circuitry are common circuitry known in the art for communication utilizing at least two well known communication protocols, and serve as means for transmitting and receiving voice and data. Database 507 comprises standard random access memory and is used to store PMI values and their associated ranging code.

During operation, receiver 505 will receive a ranging code or a random-access preamble as part of a mobile station's initial system access. Microprocessor 503 will receive the ranging code and access database 507 to determine a PMI associated with the ranging code. As discussed above, when the base station receives a ranging code, it is required to estimate the timing offset and the power for the mobile station. The base station is required to broadcast the detected ranging code with adjustment instructions for the timing and power level. The status notifications of either ranging successful or retransmission are also broadcasted. Because of these requirements, logic circuitry 503 will then instruct transmitter 501 to transmit the necessary information on a downlink control channel. As part of the transmit process, transmitter 501 will weight all transmissions to the mobile station accordingly (based on the received ranging code and associated PMI).

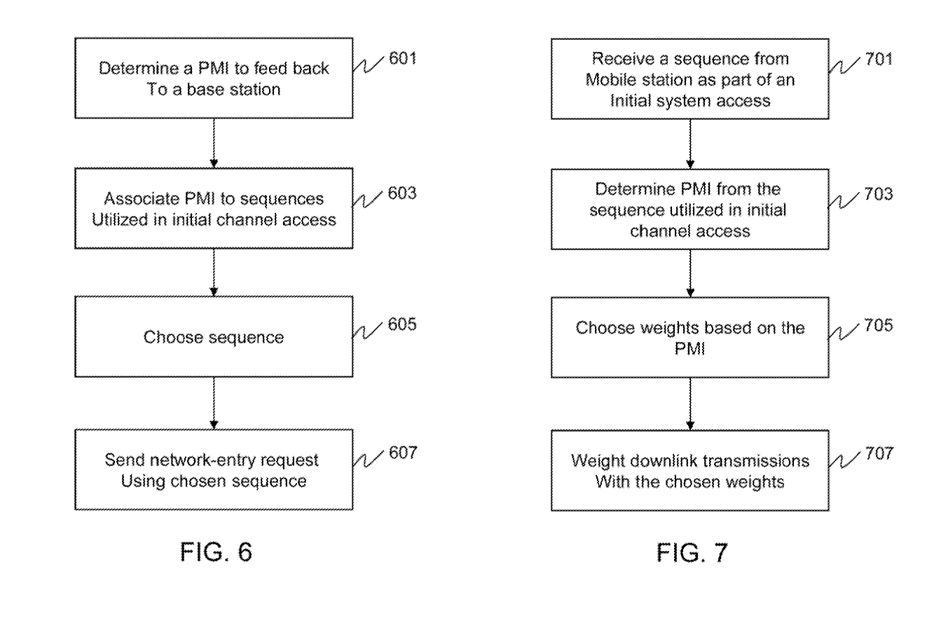

FIG. 6 is a flow chart showing operation of the mobile station of FIG. 4 during network entry. The logic flow begins at step 601 where logic circuitry 403 instructs circuitry 405 to determine appropriate downlink channel information to feed back to the base station as part of a closed-loop feedback of the downlink channel information. In one embodiment of the present invention, the downlink channel information comprises a PMI, however, any information that indicates appropriate antenna weights may be utilized. As discussed above, in order to determine the appropriate PMI, circuitry 405 utilizes receiver 402 to measure the downlink channel transmitted from the base station. In response to this measurement, circuitry 405 will determine a transmit weight vector needed to optimize the data reception at the mobile station when the same transmit weight vector is used by the base station to transmit data to the mobile station.

Logic circuitry 403 receives a PMI from circuitry 405. As discussed above, the PMI is basically an index into a codebook used by the base station and the mobile station. Logic circuitry 403 then accesses database 407 and associates the PMI with one of several numerical sequences utilized as an initial access into the communication system (step 603). As discussed above, the numerical sequences are preferably an 802.16 ranging code or an LTE random-access preamble. Logic circuitry 403 then randomly chooses one numerical sequence from the numerical sequences associated with the PMI (step 605). Finally, at step 607, logic circuitry utilizes transmitter 401 to send a network-entry request comprising the chosen numerical sequence. In response, all communications from base station to the mobile station are transmitted with the appropriate channel weights that were determined from the PMI associated with the numerical sequence. Therefore, receiver 402 will receive downlink control channel transmissions from the base station that are weighted based on the numerical sequence. In particular, the downlink control channel transmissions are received from the base station that are weighted with antenna weights chosen based on the numerical sequence.

As discussed above, because the base station is provided with the PMI prior to the mobile station accessing the system, the base station can tailor any transmissions to the mobile station accordingly. This allows for the system to apply per-user closed loop techniques on the downlink control channel when transmitting downlink unicast control messages to the mobile station. This will significantly improve range and reliability of the control channel used in IEEE 802.16m or the Long Term Evolution (LTE) of the 3GPP UMTS standard.

FIG. 7 is a flow chart showing operation of the base station of FIG. 5. The logic flow begins at step 701 where receiver 505 receives a numerical sequence (e.g., a ranging code or a random-access preamble) as part of a mobile station's initial system access request. At step 703, logic circuitry 503 will receive the numerical sequence from receiver 505 and access database 507 to determine a PMI associated with the numerical sequence. From the PMI, logic circuitry 503 will choose appropriate downlink antenna weights to utilize when transmitting to the mobile station (step 705). As is evident, the downlink antenna weights are determined directly from the numerical sequence by associating the numerical sequence with the PMI. Logic circuitry 503 will then instruct transmitter 501 to transmit the necessary information on a downlink control channel, appropriately weighted with the chosen antenna weights (step 707).

The preceding discussion focused on the concept of using the ranging sequences to simultaneously signal both a ranging sequence and a PMI value. The particular PMI value being conveyed to the base station was indicated by the particular ranging sequence that the mobile station transmitted to the base station. The preceding discussion focused on using the ranging sequences to facilitate the PMI feedback methodology for codebook-based downlink transmission. An alternate feedback methodology contained in the IEEE 802.16m draft specification involves the mobile station feeding back a numerically quantized version of the downlink spatial covariance matrix rather than a PMI value. The Base station can then compute transmit weights based on the fed back covariance matrix. The number of bits required to convey the quantized covariance matrix depends on the number of base station antennas. For example, for two, four, or eight base station transmit antennas, the number of bits required to convey the spatial covariance matrix is 6, 28, and 120 respectively. The methodology of the preceding discussion can be leveraged such that the particular ranging code that is sent back corresponds to a particular quantized covariance matrix. To support this type of feedback on the ranging channel, the total number of available ranging sequences is partitioned into some number of groups each containing a set of ranging sequences. The number of groups is equal to the total number of possible feedback combinations for specifying the quantized covariance matrix. The user computes the quantized covariance matrix and randomly selects a ranging sequence from the group that corresponds to the calculated quantized covariance matrix. During the ranging process, the mobile station will transmit its selected ranging sequence, and the base station will determine the quantized covariance matrix based on the received ranging sequence.

The methodology in the present disclosure can be applied to other forms of quantized channel feedback, where in general, the number of ranging sequences used by the system must be chosen to be at least the number of possible feedback messages that can be sent by the mobile station during the ranging process. Preferably, the number of ranging sequences used by the system should be some multiple of the number of the number of possible feedback messages to reduce the possibility of two mobiles sending the same ranging sequence if those two mobiles have the same feedback message to send. In general the feedback can be forms of channel feedback other than PMI or quantized covariance matrix. For example, the information conveyed by the particular ranging sequence can be used to indicate a mobile station's Channel Quality Information (CQI) state, a quantized estimate of the mobile station's velocity, a quantized estimate of the mobile station's delay spread or some other parameter of the channel between the base station and the mobile station.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method for a mobile unit to provide closed-loop feedback to a base station, the method comprising the steps of:
determining appropriate downlink channel information to feed back to the base station as part of a closed-loop feedback of the downlink channel information;
associating the downlink channel information with a numerical sequence used for initial access to a communication system;
sending a request to join the communication system, the request comprising the numerical sequence; and
receiving downlink control channel transmissions from the base station that are weighted based on the numerical sequence.

2. The method of claim 1 wherein the numerical sequence comprises a ranging code or a random-access preamble.

3. The method of claim 1 wherein the downlink channel information comprises a precoding matrix index (PMI) or a quantized covariance matrix.

4. The method of claim 1 wherein the step of receiving the downlink control channel comprises the step of receiving the downlink control channel transmissions from the base station that are weighted with antenna weights chosen based on the numerical sequence.

5. A method for a mobile unit to provide closed-loop feedback to a base station, the method comprising the steps of:
determining a precoding matrix index (PMI) to feed back to the base station as part of a closed-loop feedback of the downlink channel information;
associating the PMI with a ranging code or a random-access preamble used for initial access to a communication system;
sending a request to join the communication system, the request comprising the ranging code or random-access preamble; and
receiving downlink control channel transmissions from the base station that are weighted based on the PMI.

6. A method for a base station to determine appropriate channel weightings for a mobile unit during closed-loop feedback, the method comprising the steps of:
receiving a request to join a communication system, the request comprising a numerical sequence;
determining downlink antenna weights to utilize when transmitting to the mobile station based on the numerical sequence; and
transmitting information on a downlink control channel, appropriately weighted with the chosen antenna weights.

7. The method of claim 6 further comprising the step of determining a precoding matrix index (PMI) based on the numerical sequence and using the PMI to determine the downlink antenna weights.

8. The method of claim 6 wherein the numerical sequence comprises a ranging code or a random-access preamble.

9. An apparatus comprising:
calculation circuitry determining appropriate downlink channel information to feed back to the base station as part of a closed-loop feedback of the downlink channel information;
logic circuitry associating the downlink channel information with a numerical sequence used for initial access to a communication system;
a transmitter sending a request to join the communication system, the request comprising the numerical sequence; and
a receiver receiving downlink control channel transmissions from the base station that are weighted based on the numerical sequence.

10. The apparatus of claim 9 wherein the numerical sequence comprises a ranging code or a random-access preamble.

11. The apparatus of claim 9 wherein the downlink channel information comprises a precoding matrix index (PMI).

12. The apparatus of claim 9 wherein the step of receiving the downlink control channel comprises the step of receiving the downlink control channel transmissions from the base station that are weighted with antenna weights chosen based on the numerical sequence.

13. An apparatus comprising:
a receiver receiving a request to join a communication system, the request comprising a numerical sequence;
logic circuitry determining a precoding matrix index (PMI) based on the numerical sequence and also determining downlink antenna weights to utilize when transmitting to the mobile station; and
a transmitter transmitting information on a downlink control channel, the information appropriately weighted with the chosen antenna weights.

14. The apparatus of claim 13 wherein the numerical sequence comprises a ranging code or a random-access preamble.
